(19) United States
(12) Patent Application Publication
(10) Pub. No.: US 2015/0035806 A1
(43) Pub. Date: Feb. 5, 2015

(54) INFORMATION PROCESSING APPARATUS, NON-TRANSITORY STORAGE MEDIUM ENCODED WITH COMPUTER READABLE INFORMATION PROCESSING PROGRAM, INFORMATION PROCESSING SYSTEM, AND INFORMATION PROCESSING METHOD

(71) Applicant: NINTENDO CO., LTD., Kyoto-shi (JP)

(72) Inventors: Fumiya SUTO, Kyoto-shi (JP); Keizo OHTA, Kyoto-shi (JP)

(73) Assignee: NINTENDO CO., LTD., Kyoto-shi (JP)

(21) Appl. No.: 14/073,011

(22) Filed: Nov. 6, 2013

(30) Foreign Application Priority Data
Aug. 2, 2013 (JP) 2013-161063

(51) Int. Cl. G06F 3/043

(52) U.S. Cl. CPC G06F 3/043
USPC 345/177

(57) ABSTRACT

An information processing apparatus includes a detection unit configured to detect sound resulting from an operation performed on a unit subject to operation, a calculation module configured to calculate an integrated value of magnitude of detected sound resulting from the operation over a predetermined period, and a processing module configured to execute specific processing based on the integrated value of magnitude.

This nonprovisional application is based on Japanese Patent Application No. 2013-161063 filed on Aug. 2, 2013, with the Japan Patent Office, the entire contents of which are hereby incorporated by reference.

### FIELD

The technology herein relates to an information processing apparatus that executes processing in accordance with an operation amount on a unit subject to operation, a non-transitory storage medium encoded with a computer readable information processing program therefor, an information processing system therefor, and an information processing method therefor.

### BACKGROUND AND SUMMARY

A technique for conducting information processing through use of information on an input operation and operation sound thereby produced.

The above-mentioned background art merely teaches executing information processing through use of information on an input operation and operation sound thereby produced, and no consideration is given to a new subject such as reducing the influence on operability using these pieces of information irrespective of any change in the situation, environment or method of an input operation.

Exemplary embodiments provide an information processing apparatus capable of reducing the influence on operability irrespective of any change in the situation, environment, method or the like of an input operation, a computer readable information processing program therefor, an information processing system therefor, and an information processing method therefor.

An exemplary embodiment provides an information processing apparatus that includes a detection unit configured to detect sound resulting from an operation performed on a unit subject to operation, a calculation module configured to calculate an integrated value of magnitude of detected sound resulting from the operation over a predetermined period, and a processing module configured to execute specific processing based on the integrated value of magnitude.

According to the exemplary embodiment, since the information processing apparatus executes processing based on the integrated value of magnitude of detected sound resulting from the operation over a predetermined period, the influence on operability can be reduced irrespective of any change in the situation, environment, method, or the like of an input operation.

In the exemplary embodiment, the information processing apparatus further includes an input unit including the subject unit. The detection unit is configured to detect sound when the operation is performed on the subject unit. According to the exemplary embodiment, a wide variety of processing can be achieved based on an input operation on the input unit including the subject unit and the determined operation amount.

In the exemplary embodiment, the input unit includes a touch panel. According to the exemplary embodiment, the strength (intensity) of an input operation on the touch panel that only enables detection of a coordinate value of an operation can be recognized, and a wider variety of processing can be achieved.

In the exemplary embodiment, the input unit includes a button. According to the exemplary embodiment, the strength (intensity) of an input operation on the button that only enables detection of the presence/absence of operation (ON/OFF) can be recognized, and a wider variety of processing can be achieved.

In the exemplary embodiment, the processing module executes the specific processing based on a position where an input operation has been performed in addition to the integrated value of magnitude. According to the exemplary embodiment, since the specific processing can be executed upon correction of the integrated value of magnitude based on the position where the input operation has been performed, the influence caused by the distance between the detection unit and the position where the input operation has been performed can be reduced.

In the exemplary embodiment, the calculation module calculates the integrated value over the predetermined period that is a fixed period. According to the exemplary embodiment, since the integrated value is calculated for the fixed period, calculation processing of the integrated value can be simplified.

In the exemplary embodiment, the calculation module is further configured such that the predetermined period for which the integrated value is calculated is variable. According to the exemplary embodiment, since the period for which the integrated value is calculated can be dynamically determined in accordance with the result of detection made by the detection unit, calculation accuracy of the integrated value can be improved.

In the exemplary embodiment, the calculation module calculates the integrated value over a period in which the magnitude of detected sound is more than or equal to a predetermined value. According to the exemplary embodiment, since the integrated value can be calculated through use of information on a period providing higher accuracy based on the magnitude of detected sound, calculation accuracy can be improved.

In the exemplary embodiment, the processing module calculates an operation amount on the subject unit based on the integrated value of magnitude, and executes the specific processing based on the operation amount. According to the exemplary embodiment, since processing is executed upon calculation of a specific operation amount, the operation amount can be corrected. Moreover, reusability of the calculated operation amount can be improved.

In the exemplary embodiment, the processing module determines the operation amount on the subject unit using an index indicating hardness of a material used for the operation on the subject unit. According to the exemplary embodiment, even when the calculated integrated value fluctuates depending on the hardness of a material used for the operation on the subject unit, such fluctuations can be corrected, and the operation amount can be determined stably.

In the exemplary embodiment, the processing module corrects the integrated value of magnitude such that the calculated operation amount on the subject unit is larger as the degree of hardness of a material used for the operation on the subject unit is smaller. According to the exemplary embodiment, since the calculated integrated value tends to be smaller as the degree of hardness of a material used for the operation on the subject unit is smaller, suitable correction can be performed in accordance with this tendency.

In the exemplary embodiment, the index indicating hardness is a value based on a maximum value of the detected sound. According to the exemplary embodiment, since the operation amount is determined using not only the integrated value but also information on the maximum value of the detected sound, accuracy of determining the operation amount can be improved.

An exemplary embodiment provides a non-transitory storage medium encoded with a computer readable information processing program, executed by a processor, the information processing program causing the processor to perform functionality that includes detecting sound resulting from an operation performed on a unit subject to operation, calculating an integrated value of magnitude of detected sound resulting from the operation over a predetermined period, and executing specific processing based on the integrated value of magnitude.

An exemplary embodiment provides an information processing system that includes a detection unit configured to detect sound resulting from an operation performed on a unit subject to operation, an acquisition module configured to acquire the result of detection made by the detection unit, a calculation module configured to calculate an integrated value of magnitude of detected sound resulting from the operation over a predetermined period, and a processing module configured to execute specific processing based on the integrated value of magnitude.

An exemplary embodiment provides an information processing method executed in an information processing apparatus. The information processing method includes detecting sound resulting from an operation performed on a unit subject to operation, calculating an integrated value of magnitude of detected sound resulting from the operation over a predetermined period, and executing specific processing based on the integrated value of magnitude.

According to the exemplary embodiments, operation effects similar to those of the above-described illustrative embodiments are exerted.

The foregoing and other objects, features, and aspects and advantages of the present invention will become more apparent from the following detailed description of the present invention when taken in conjunction with the accompanying drawings.

### BRIEF DESCRIPTION OF THE DRAWINGS

FIGS. 1A and 1B show exemplary illustrative non-limiting schematic diagrams each illustrating an example of an input operation on a unit subject to operation.

FIGS. 2A and 2B show exemplary illustrative non-limiting time waveforms of operation sound produced by the operations as shown in FIGS. 1A and 1B.

FIG. 3 schematically shows an exemplary illustrative non-limiting block diagram of a processing outline according to an exemplary embodiment.

FIG. 4 shows an exemplary illustrative non-limiting schematic diagram illustrating an implementation example of an information processing apparatus according to an exemplary embodiment.

FIG. 5 shows an exemplary illustrative non-limiting flow chart illustrating a procedure of an information processing method according to an exemplary embodiment.

FIG. 6 shows an exemplary illustrative non-limiting schematic diagram illustrating an application example executed by an information processing apparatus according to an exemplary embodiment.

FIGS. 7A and 7B show exemplary illustrative non-limiting experimental examples illustrating the result of calculation of degree of softness according to an exemplary embodiment.

### DETAILED DESCRIPTION OF NON-LIMITING EXAMPLE EMBODIMENTS

Embodiments will be described in detail with reference to the drawings. It is noted that, in the drawings, the same or corresponding portions have the same reference characters allotted, and detailed description thereof will not be repeated.

### A. Subject

First, a new subject found by the inventors of the present application for processing of determining an operation amount by detecting an input operation such as a touch operation, a tap operation or a pressing operation, and sound resulting from the input operation will be described.

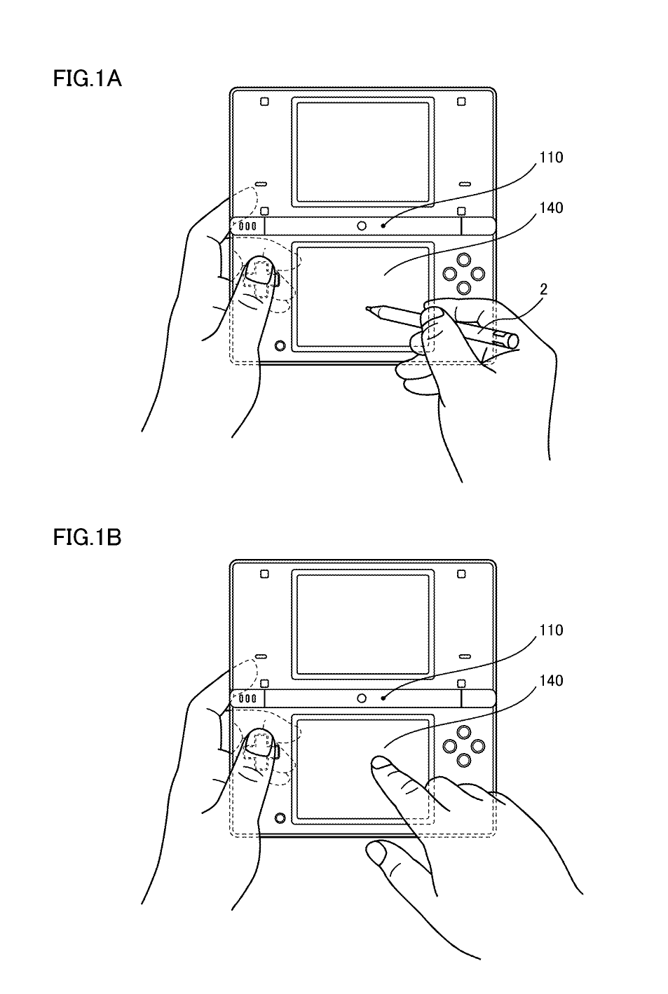

FIGS. 1A and 1B illustrate an information processing apparatus including a touch panel 140 as an input unit as a configuration example capable of receiving an input operation. The input unit of the information processing apparatus according to the present embodiment is not limited to touch panel 140.

In order to detect the strength of an operation performed on such an input unit including a unit subject to operation (hereinafter referred to as the “subject unit”), processing through use of sound resulting from that operation will be considered. More specifically, sound produced by an operation on touch panel 140 is detected with a microphone 110 disposed in proximity to touch panel 140, and the operation amount is determined based on the detected value.

Throughout the present specification, “the operation amount” refers to the strength (intensity) of an operation on the subject unit of the input unit (in the examples of FIGS. 1A and 1B, the surface of touch panel 140). This strength (intensity) of an operation may indicate the degree of force actually applied to the subject unit (an objective value), or may indicate the degree of force a user feels that he/she has applied to the subject unit (a subjective value).

A method of using an instantaneous volume of sound detected by a detection unit (typically, microphone 110) is conceivable as such a processing example of determining the operation amount. More specifically, a method for proportioning the maximum value of detected sound and the strength of a touch, namely, the operation amount. That is, a value indicating the strength of a touch can be calculated by multiplying the maximum value of sound detected with microphone 110 functioning as the detection unit by a predetermined fixed value.

However, the inventors of the present application have found out that such a method for determining the operation amount cannot satisfactorily cope with any change in the situation, environment or method of an input operation. That is, a change in the situation, environment or method of an input operation causes fluctuations or changing tendency in the determined operation amount, with the result that operability perceived by the user may be degraded.

For example, as shown in FIG. 1A, relatively many high frequency components are included in operation sound produced when the user performs an input operation with a stylus (touch pen) 2, while as shown in FIG. 1B, relatively many low frequency components are included in operation sound produced when the user performs an input operation with his/her own finger. That is, even in operations performed by the same user, sound quality of produced sound will vary depending on the difference in physical properties (typically, hardness) between the subject unit and a material used for the operation. As a result, the feature of detected sound (typically, time variation) will also vary.

When the situation, environment or method of an input operation changes as described above, the maximum value of the detected sound will also change. When processing of determining the operation amount on the subject unit only through use of the maximum value is adopted, a determined operation amount will be greatly deviated from an operation amount previously assumed by the user, and operability perceived by the user may be degraded.

The information processing apparatus, information processing program, information processing system, and information processing method according to the present embodiment cover processing and configuration that prevent the influence on operability from being degraded irrespective of any change in the situation, environment or method of an input operation. Hereinafter, the processing and configuration will be described in detail.

### B. Means for Solution

Means for solving the problems according to the present embodiment will now be described.

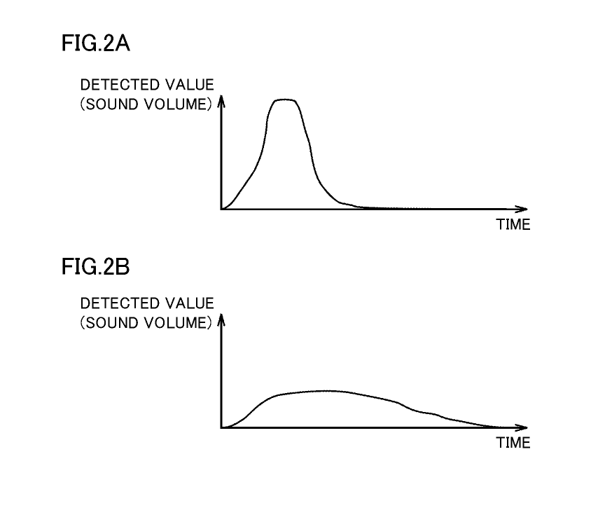

FIG. 2A shows an exemplary time waveform of operation sound detected when an input operation is performed with stylus 2 as shown in FIG. 1A, and FIG. 2B shows an exemplary time waveform of operation sound detected when an input operation is performed with a user's own finger as shown in FIG. 1B. As shown in FIGS. 2A and 2B, different features appear in sound to be produced depending on the properties of a material used for an input operation.

That is, comparing an operation performed with a material which is relatively hard like stylus 2 and an operation performed with a material which is relatively soft like a finger, the peak (maximum value) and a time length of the entire waveform will be different. That is, operation sound having a sharp time waveform as shown in FIG. 2A (having relatively many high frequency components) is produced with stylus 2, while relatively dull operation sound as shown in FIG. 2B (having relatively many low frequency components) is produced with a finger.

Experiments conducted by the inventors of the present invention have revealed that the feature of operation sound to be produced varies depending on the difference in physical properties (typically, hardness) between the subject unit and a material used for an operation. Then, in the present embodiment, the operation amount made by the user (strength of a touch) is determined through use of an “area” on the time waveform of detected sound. In the present embodiment, an integrated value of magnitude of sound over a predetermined period is used as a value indicating this “area.” As shown in FIG. 2B, the maximum value of operation sound produced when an operation is performed with a relatively soft material is small, while the duration of sound is long. Therefore, by using an integrated value, that is, the area of a predetermined period in a time waveform of sound as an index, the difference arising in the result of detection due to the difference in hardness can be reduced.

Throughout the present specification, the “integrated value” is a term contrasted with an instantaneous volume of sound, and refers to a value calculated by integrating detected sound over a certain period. This integrated value may include the total sum of values indicating the level of sound in a target period and the average of values indicating the level of sound in a target period. The calculated integrated value may be obtained by directly summing/averaging values (raw values) indicating the level of detected sound, or may be a value upon multiplication by such values by an appropriate coefficient or necessary conversion processing so as to be suitable for subsequent processing.

It is noted that, as will be described later, the period (time) for which the integrated value is to be calculated may be a predetermined fixed value, or may be a value varied as appropriate depending on the level of detected sound or the like.

As another more preferable embodiment, the operation amount may be determined upon performing correction using not only the “integrated value” but also an index indicating the “degree of softness”, namely, the “hardness” of a material used for an operation on a unit subject to operation.

More specifically, to determine the strength of a touch (the operation amount) from the maximum value of detected sound, as the material used for the operation on the subject unit is harder, the material is likely to be determined as a stronger value, as shown in FIG. 2A. Therefore, by determining the operation amount in consideration of the “degree of softness” of the material used for these operations, the difference in the result that may be caused by the difference in hardness of the material used for the operation (even with the same operation amount for the user) is reduced. The integrated value as described above can also be used as an index indicating the “degree of softness” of a material used for the operation on the subject unit.

### C. Summary of Processing

Next, the summary of processing according to the present embodiment will be given.

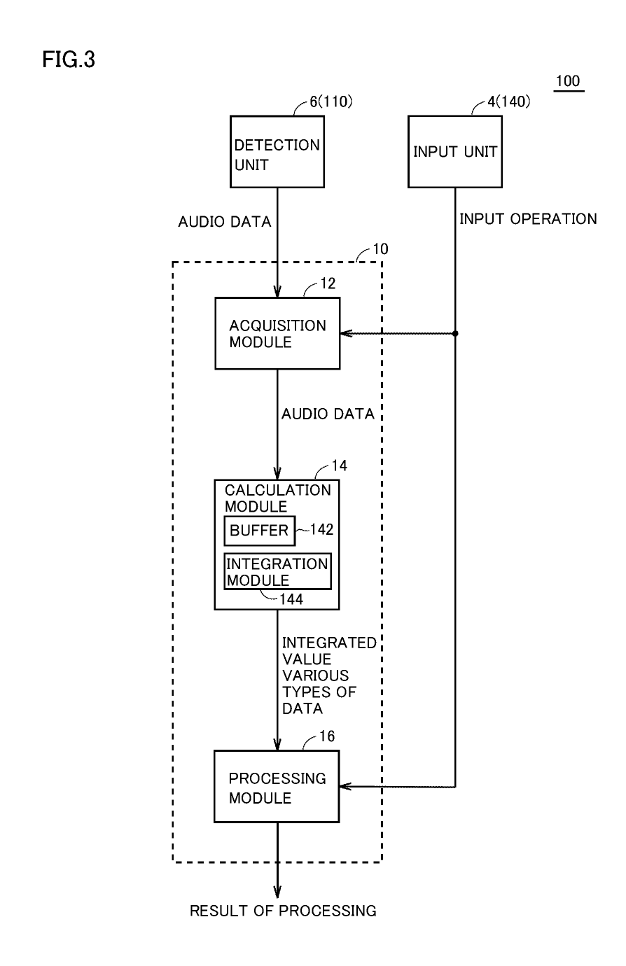

Referring to FIG. 3, an information processing apparatus 100 according to the present embodiment includes a processing function 10 outputting the result of processing based on information received from an input unit 4 and a detection unit 6 (typically, microphone 110). Processing function 10 includes an acquisition module 12, a calculation module 14 and a processing module 16.

Input unit 4 corresponds to an input unit including the subject unit receiving an input operation, and is typically mounted as touch panel 140 described above or a button.

Detection unit 6 detects sound resulting from an operation performed on the subject unit included in input unit 4. Detection unit 6 outputs audio data indicating the result of detection to processing function 10.

Acquisition module 12 acquires the result of detection made by detection unit 6. Although the example shown in FIG. 3 shows acquisition module 12 as a kind of interface acquiring the audio data detected by detection unit 6 for output to calculation module 14, acquisition module 12 itself may include the function of detection unit 6. That is, detection unit 6 and acquisition module 12 shown in FIG. 3 may be formed as a unit. In the example shown in FIG. 3, a trigger indicating that a certain input operation has been performed on input unit 4 is supplied to acquisition module 12, and in response to this trigger, acquisition module 12 acquires audio data in a required period.

Calculation module 14 receives the audio data acquired by acquisition module 12, and calculates the integrated value of magnitude of sound resulting from a detected operation over a predetermined period. More specifically, calculation module 14 includes a buffer 142 for storing audio data in time series, and an integration module 144 for calculating an integrated value from audio data stored in buffer 142. Calculation module 14 outputs the integrated value calculated by integration module 144 and other required information to processing module 16.

Processing module 16 executes various types of processing through use of an input operation detected by input unit 4 and audio data detected by detection unit 6. In the present embodiment, processing module 16 executes specific processing based on the integrated value of magnitude of sound detected by detection unit 6. Here, processing module 16 determines the operation amount on the subject unit included in input unit 4. Processing executed by processing module 16 includes various types of communication processing and user interactive processing, in addition to game processing which will be described later.

### D. Implementation Example

Next, an implementation example of the information processing apparatus according to the present embodiment will be described.

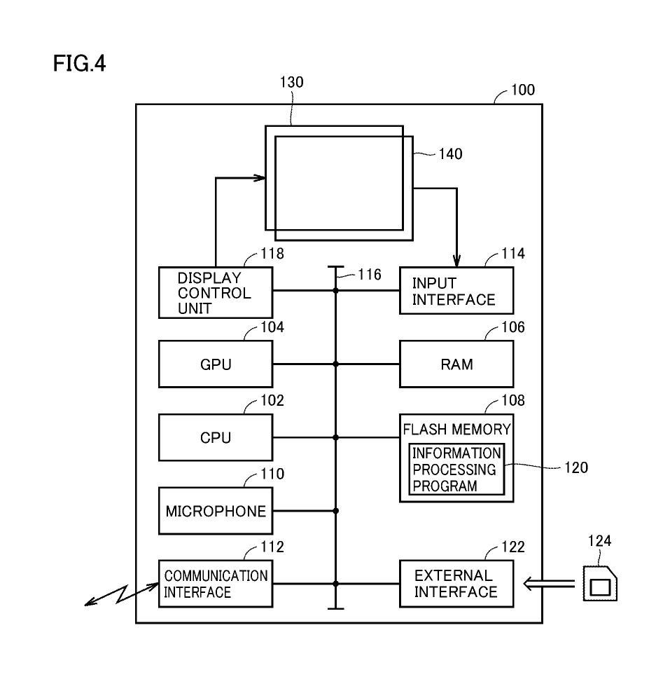

Referring to FIG. 4, information processing apparatus 100 includes, as main hardware, a CPU (Central Processing Unit) 102, a GPU (Graphical Processing Unit) 104, a RAM (Random Access Memory) 106, a flash memory 108, microphone 110, a communication interface 112, an input interface 114, a display control unit 118, and an external interface 122. These components are connected to one another via a bus 116.

CPU 102 is an essential part of processing which executes various programs. GPU 104 executes processing of producing a captured image as will be described later, in cooperation with CPU 102. RAM 106 functions as a working memory which stores data, parameters, and the like necessary for execution of a program in CPU 102 and GPU 104. Flash memory 108 stores in a nonvolatile manner an information processing program 120 executed in CPU 102, various parameters set by a user, and the like.

Microphone 110 is a device for gathering sound produced around information processing apparatus 100, and particularly detects sound resulting from an operation performed on the subject unit.

Display control unit 118 outputs a video signal or the like to display device 130 in accordance with an internal command from CPU 102 and/or GPU 104. Communication interface 112 sends/receives data to/from another device by wire or wirelessly. Input interface 114 receives an operation signal from input device 140 for output to CPU 102. Instead of or in addition to touch panel 140, any operation button may be mounted as the input unit.

External interface 122 is capable of reading, from recording medium 124 of any type, data such as a program stored therein, and writing various types of data stored in flash memory 108 or the like to non-transitory recording medium 124.

Although FIG. 4 shows an example of information processing apparatus 100 with microphone 110, display device 130 and touch panel 140 incorporated therein, some or all of these components may be formed separately from information processing apparatus 100. That is, the present invention can also be implemented as an information processing system composed of an processing device according to the present embodiment and a component for exchanging information an/or signals with the processing device.

The information processing apparatus or the information processing system according to the present embodiment may be typically mounted as a smart phone, PDA (Personal Digital Assistance), a cellular phone, a portable game apparatus, a digital camera, or the like, or may be mounted as a personal computer, a console-type game device, a set top box, or the like. The substance of the present technique is a technical idea defined by the matters recited in the claims, and if an implementation not described in the present specification is achieved in the future, such an implementation will belong to the technical scope of the present invention as long as it covers the technical idea of the present technique.

Moreover, an aspect of the present technique also includes an information processing program for achieving the information processing method performed in the information processing apparatus or the information processing system according to the present embodiment and a recording medium storing the information processing program therein. When such an information processing program is executed by a computer (specifically, a processor such as CPU 102) serving as the information processing apparatus, functions indicated by the respective blocks shown in FIG. 3 are achieved by the information processing apparatus.

### E. Procedure

Next, an exemplary procedure of the information processing method executed in the information processing apparatus or the information processing system according to the present embodiment will be described.

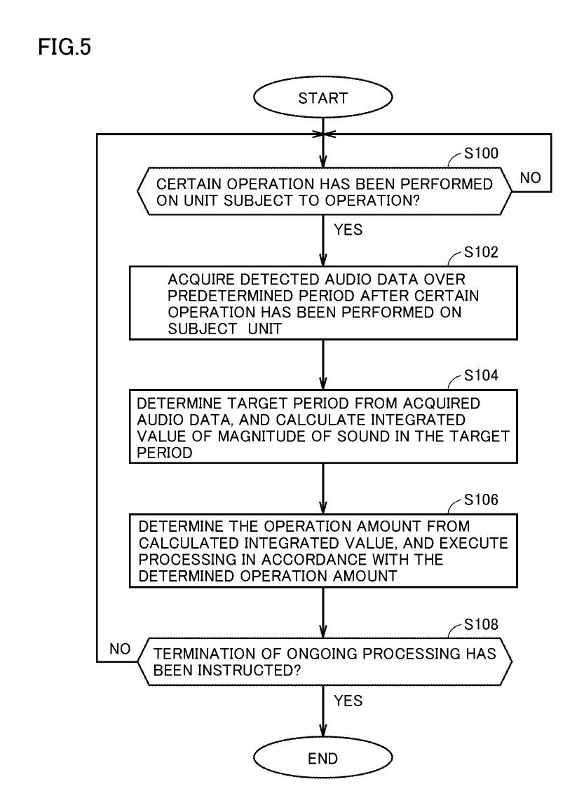

Typically, each step shown in FIG. 5 is achieved by the essential part of processing (CPU 102 and/or GPU 104) shown in FIG. 4 executing information processing program 120. Instead of implementation by such software, the whole or part of processing may be achieved by hardware. For ease of description, a description will be given assuming that the information processing method according to the present embodiment is achieved by CPU 102 of information processing apparatus 100 executing information processing program 120.

Referring to FIG. 5, CPU 102 of information processing apparatus 100 determines whether or not a certain operation has been performed on touch panel 140 (unit subject to operation) serving as the input unit (step S100). When no operation has been performed on touch panel 140 (unit subject to operation) serving as the input unit (NO in step S100), processing of step S100 is repeated.

On the other hand, when a certain operation has been performed on touch panel 140 (unit subject to operation) serving as the input unit (YES in step S100), CPU 102 acquires audio data detected with microphone 110 serving as the detection unit over a predetermined period after a certain operation has been performed on touch panel 140 (unit subject to operation) (step S102). CPU 102 acquires audio data for a certain time after a touch operation is made on touch panel 140. That is, CPU 102 executes processing of acquiring the result of detection of sound resulting from an operation made on the subject unit.

It is noted that audio data detected with microphone 110 may always be stored for the latest predetermined cycle using a ring buffer or the like, while required partial data may be extracted from the audio data stored in this ring buffer with detection of a certain operation on touch panel 140 (unit subject to operation) serving as a trigger, and may be used for processing.

Then, CPU 102 determines a target period from the acquired audio data, and calculates the integrated value of magnitude of sound in the target period (step S104). That is, CPU 102 executes processing of calculating the integrated value of magnitude of sound resulting from the detected operation over a predetermined period.

As a specific example of this processing of determining a target period, a section of a specific length in which the sum of absolute values of detected sound volumes will be the maximum is searched for, and the sum of absolute values of sound volumes in that section obtained by searching is determined as an integrated value (area).

As a typical implementation, audio data is acquired over a period sufficiently longer than the period for which the integrated value is calculated, and the integrated value is calculated using a component in a section having a fixed length included in the acquired audio data. For example, assuming that the time change in audio data is [8, −1, 2, −4, −6, 4, 2, 1] and the length of the section as 3, the sum of absolute values becomes the maximum in the portion of [−4, −6, 4] among the sections having a length of 3, and the integrated value is calculated as “14.” That is, CPU 102 calculates an integrated value over the predetermined period that is a fixed period.

When the integrated value is calculated by processing as described above, CPU 102 determines the operation amount from the calculated integrated value, and executes processing in accordance with the determined operation amount (step S106). That is, based on the integrated value of magnitude of sound resulting from the detected operation over the predetermined period, CPU 102 determines the operation amount on touch panel 140 (unit subject to operation) serving as the input unit, and executes processing. As the easiest processing method, CPU 102 may determine the calculated integrated value directly as the strength of a touch operation, that is, the operation amount.

Then, CPU 102 determines whether or not termination of the ongoing processing has been instructed (step S108). That is, it is determined whether or not termination of the processing based on the operation amount as described above has been instructed. When termination of the ongoing processing has not been instructed (NO in step S108), processing of and subsequent to step S100 is repeated.

On the other hand, when termination of the ongoing processing has been instructed (YES in step S108), the processing is terminated.

In accordance with the above procedure, the information processing method according to the present embodiment is executed repetitively.

### F. Application Example

### Processing Example in Accordance with the Operation Amount

In order to deepen understanding of the present embodiment, an application example relevant to the processing executed in step S106 of FIG. 5 will be described.

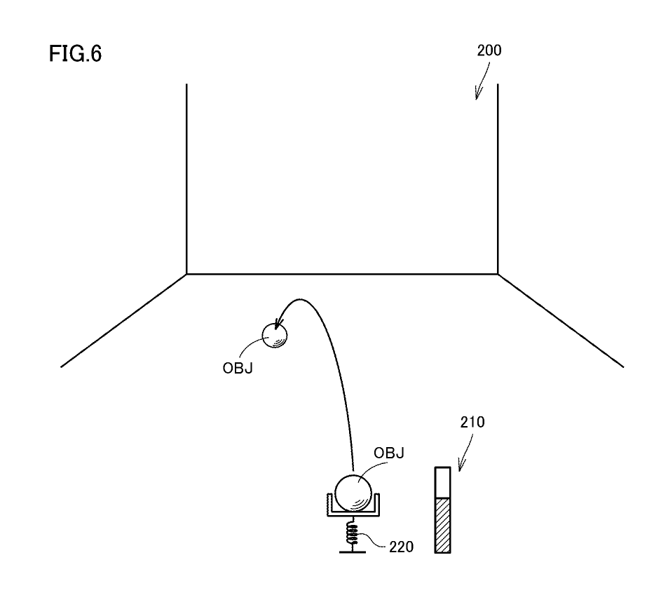

FIG. 6 shows game processing such as flipping a spherical object OBJ in accordance with a user's input operation, as an application example. In a three-dimensional space 200, object OBJ disposed at a launcher 220 is ejected by a strength in accordance with the operation amount calculated in response to a user's operation. This operation amount calculated in response to the user's operation is displayed on an indicator 210 disposed adjacent to launcher 220.

The user controls the injection amount of object OBJ by adjusting the operation on the subject unit, and plays such that a higher mark is calculated under a predetermined rule.

The processing in accordance with the operation amount executed in the information processing apparatus according to the present embodiment is not limited to such a game, but also includes various types of processing.

### G. Variation of Processing of Determining Target Period for which Integrated Value is Calculated

The processing of searching for a section of a predetermined length in which the sum of absolute values of detected sound volumes becomes the maximum and determining the integrated value from the section obtained by searching has been described above. That is, processing in the case where CPU 102 calculates the integrated value over a predetermined period that is a fixed period has been described.

Instead of this, the length of the target period for which the integrated value is determined may be varied as appropriate. That is, it may be configured such that the predetermined period for which the integrated value is calculated is variable. In other words, the target period for which the integrated value is calculated may be determined dynamically in accordance with audio data as the result of detection made by detection unit 6.

As an example of such a method for determining the target period dynamically, a section whose amplitude (absolute value) exceeds a predetermined threshold among detected audio data may be extracted as a target period, and the integrated value may be calculated from audio data of the extracted period. That is, the integrated value may be calculated over a period in which a detected magnitude of sound is more than or equal to a predetermined value.

As another example of a method for determining the target period dynamically, a section in which the time change in detected audio data (e.g., time differential, etc.) satisfies certain conditions may be extracted as a target period, and the integrated value may be calculated from audio data of the extracted period. Furthermore, a target period may be extracted using other conditions.

### H. Variation of Operation Amount Determination Processing

[h1: Outline of Degree of Softness]

The above-described embodiment illustrates processing of determining a calculated integrated value directly as the operation amount has been illustrated, however, correction processing through use of an index indicating the “degree of softness” may be included. In other words, upon performing correction through use of an index indicating the “degree of softness”, that is, the “hardness” of a material used for an operation on the subject unit, the operation amount may be determined. Hereinafter, such processing of determining the operation amount including the correction processing through use of the “degree of softness” will be described.

By including the correction processing through use of the “degree of softness”, a deviation between an operation amount expected by an input operation performed by the user and an actually calculated operation amount can be reduced depending on the hardness of a material used for the operation.

Although various methods for calculating the “degree of softness” can be considered, a typical calculation example will be described below.

[h2: Calculation Example 1 of Degree of Softness]

As an example, the degree of softness is defined as “integrated value (area)/maximum sound volume (maximum peak of sound).” This definition focuses on the fact that, in view of the feature of detected sound, the maximum sound volume becomes larger as the operation is performed with a relatively harder material if the integrated value (area) is the same. Here, the “maximum sound volume” basically refers to the maximum value included in the detected audio data. When a plurality of peaks are included in the detected audio data, however, the second peak may be extracted after performing noise rejection. Even in such a case, it means that a substantial maximum value included in audio data is determined as the “maximum sound volume.”

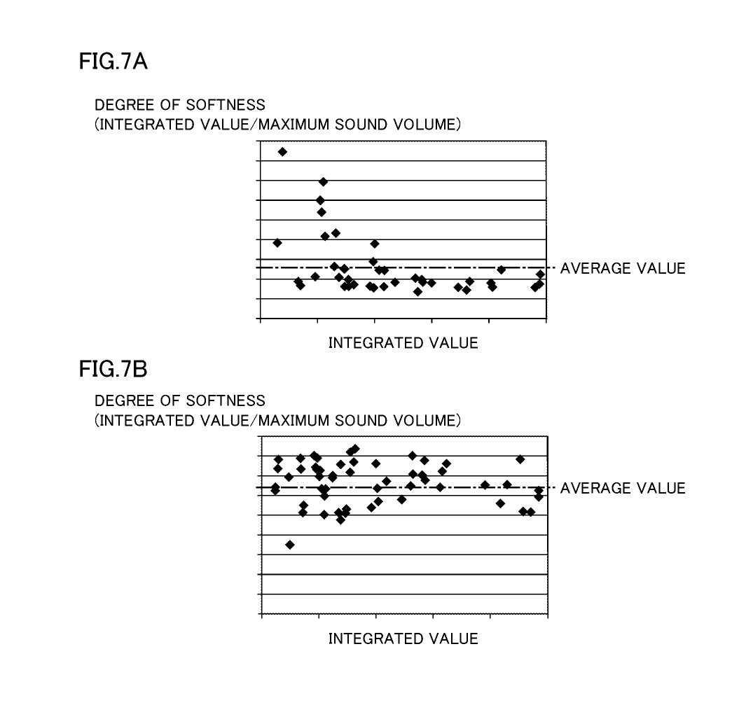

FIGS. 7A and 7B show the result obtained by the same user having performed several input operations and having plotted the degree of softness calculated for each input operation. More specifically, FIG. 7A shows an experimental example when an input operation has been performed with stylus 2 as shown in FIG. 1A, and FIG. 7B shows an experimental example when an input operation has been performed with a user's own finger as shown in FIG. 1B.

A comparison between FIG. 7A and FIG. 7B reveals that (the average value of) the degree of softness calculated differs because of the difference in hardness between materials used for the operation. In these experimental examples, (the average value of) the degree of softness obtained by the input operation performed with stylus 2 shown in FIG. 7A is “1.3”, and (the average value of) the degree of softness obtained by the input operation performed with the finger shown in FIG. 7B is “3.2.” That is, even if the same user performs input operations under the same conditions, the calculated integrated value will vary depending on the hardness of the material used for the operation. More specifically, the degree of softness will be lower when the operation is performed with a relatively harder material.

By performing such correction in accordance with the difference in average value, an error depending on the hardness of the material used for the operation can be reduced. More specifically, by multiplication by a correction factor in accordance with the difference between FIGS. 7A and 7B, the error produced in the calculated integrated value (i.e., the operation amount) can be reduced.

Next, an implementation example of correction processing through use of the degree of softness will be described. In the present embodiment, the operation amount is calculated in accordance with Equation (1) below.

The operation amount (strength of touch) Touch Strength=Integrated Value (Area)×Correction Factor (1)

Here, the calculated degree of softness may be used as a correction factor as it is. In the present embodiment, however, the correction factor is calculated from the degree of softness in accordance with the equation indicated below for stabilizing the processing. In FIGS. 7A and 7B, it can be seen that the experimental results fluctuate more in the vertical direction toward the left side, that is, as the integrated value is smaller. This can be said that the value of the degree of softness becomes more instable when the integrated value is relatively smaller. In order to prevent such instability, an adjustment is made in that case such that the correction factor becomes smaller. By multiplying the integrated value by this calculated correction factor, the operation amount is determined.

More specifically, the correction factor is calculated as indicated below through use of the calculated degree of softness.

(a) When the degree of softness is less than or equal to Sth1, the calculated area is utilized as it is.

Correction Factor=1:(Degree of Softness≦Sth1)

(b) When the degree of softness is more than Sth1 and less than Sth2, the correction factor is determined so as to change linearly between (a) and (c).

Correction Factor=(Degree of Softness−Sth1)(Sth2−Sth1)×(α−1)+1: (Sth1<Degree of Softness<Sth2)

(c) When the degree of softness is more than or equal to Sth2, the calculated area is multiplied by α and utilized.

Correction Factor=α:(Degree of Softness≧Sth2)

As described above, in the present embodiment, the operation amount is determined including the correction processing through use of the degree of softness. That is, the processing module according to the present embodiment determines the operation amount on the subject unit included in input unit 4 through use of the maximum value of detected sound. More specifically, the processing module determines the operation amount on the subject unit through use of the index indicating the hardness of the material used for the operation on the subject unit included in input unit 4.

Here, the integrated value is corrected such that the operation amount on the subject unit is calculated to be larger as the degree of hardness of the material used for the operation on the subject unit is smaller. That is, as the degree of softness has a larger value, the correction factor becomes larger, and a larger operation amount is calculated from the calculated integrated value.

[h3: Variation of Calculation of Operation Amount]

The above description illustrates a method for calculating the operation amount through use of the integrated value itself or the value obtained by multiplying the integrated value by the correction factor. Instead of the integrated value, the maximum sound volume may be multiplied by the correction factor to calculate the operation amount.

That is, in this variation, the operation amount is calculated in accordance with Equation (2) below.

The operation amount (strength of touch) Touch Strength=Maximum Sound volume×Correction Factor (2)

Here, since the correction factor will be a value reflecting the integrated value, the operation amount on the subject unit will be determined based on the integrated value.

[h4: Calculation Example 2 of Degree of Softness]

As another calculation example, the degree of softness may be defined as “the integrated value (area)/distribution of sound volume.” This focuses on the fact that, as the operation is performed with a relatively harder material, the sound volume fluctuates more as shown in FIGS. 2A and 2B. The degree of softness calculated by this method also has a smaller value as the operation is performed with a relatively harder material.

It is noted that the method for calculating the operation amount through use of the calculated degree of softness is similar to the above-described calculation method, and detailed description thereof will thus not be repeated.

[h5: Calculation Example 3 of Degree of Softness]

As still another calculation example, the degree of softness may be defined as “distribution of sound volume” itself. This focuses on the fact that, as the operation is performed with a relatively harder material, the area value fluctuates more as shown in the experimental examples of FIGS. 7A and 7B. The degree of softness calculated by this method also has a smaller value as the operation is performed with a relatively harder material.

It is noted that the method for calculating the operation amount through use of the calculated degree of softness is similar to the above-described calculation method, and detailed description will thus not be repeated.

[h6: Calculation Example 4 of Degree of Softness]

As described above, relatively many high frequency components are included in operation sound produced when an operation is performed with a relatively hard material, while relatively many low frequency components are included in operation sound produced when an operation is performed with a relatively soft material. Therefore, the degree of softness may be calculated based on the result obtained by converting the time waveform of sound into a frequency range. Typically, the Fourier transform or the like can be used for conversion into a frequency range. Upon conversion into a frequency range, the degree of softness can also be calculated based on the wavelength in which the primary component is present, the magnitude of amplitude included in each wavelength, or the like. The degree of softness calculated by this method also has a smaller value as the operation is performed with a relatively harder material.

It is noted that the method for calculating the operation amount through use of the calculated degree of softness is similar to the above-described calculation method, and detailed description thereof will thus not be repeated.

### I. Linked Processing with Input Operation on Subject Unit

Next, some implementation examples related to linked processing of an input operation on the to-be-operated unit of input unit 4 and the result of detection of sound made by the detection unit will be given.

[i1: Sensitivity Adjustment for Detection Unit]

When the subject unit of the input unit as shown in FIGS. 1A and 1B (in the example of FIGS. 1A and 1B, the surface of touch panel 140) has a certain area, and when the distance between the position where an input operation is performed and the detection unit (typically, microphone 110) may change to a nonnegligible degree, detection sensitivity of the detection unit may be adjusted in accordance with the position where the input operation is performed. That is, information processing apparatus 100 (processing function 10) may execute specific processing based on the position where the input operation has been performed in addition to the integrated value of magnitude. In this manner, the integrated value is corrected by the position where the input operation has been performed (touch position), accuracy can be improved more.

More specifically, when an input operation is performed on a position relatively close to the detection unit, detection sensitivity of the detection unit may be set to be relatively low, and when an input operation is performed on a position relatively distant from the detection unit, detection sensitivity of the detection unit may be set to be relatively high. It is noted that although detection sensitivity of the detection unit itself may be adjusted, the amount of correction related to the result of detection by the detection unit may be adjusted in accordance with the position where the input operation has been performed.

By performing such sensitivity adjustment for the detection unit, such a phenomenon that the determined operation amount fluctuates in accordance with the position where the user has performed an input operation can be reduced.

[i2: Sensitivity Adjustment for Input Unit]

As shown in FIGS. 1A and 1B, when touch panel 140 is adopted as the input unit, the degree of detection sensitivity (or “backlash”) as the input unit may be adjusted in accordance with the magnitude of a calculated measurement amount. For example, when a user touches gently, the coordinates of the touch are less likely to deviate, but when he/she touches strongly, the coordinates of the touch are more likely to deviate. Such sensitivity adjustment can prevent degradation in operability that would be caused by such deviation of coordinates.

For example, suppose that a certain input operation has been performed on touch panel 140 with a certain object being displayed. On this occasion, the range where “hit determination” is performed may be determined dynamically in accordance with the magnitude of the operation amount calculated from the result of detection made by the detection unit. That is, considering logic where a certain coordinate value on touch panel 140 is detected by a user input operation, and an object located within a predetermined range from this detected coordinate value is determined as “a hit”, the range (the length of radius) determined as a “hit” may be adjusted in accordance with the determined operation amount. In this case, the operation amount is determined first based on the result of detection made by the detection unit, and then processing in accordance with the input operation performed on the input unit will be determined in accordance with that determined operation amount.

By adopting such processing, highly flexible processing in accordance with a user input operation and the strength of the input operation can be achieved.

### J. Advantages

According to the present embodiment, the calculated operation amount can be determined more stably irrespective of any change in the situation, the method or the like of an input operation. This can reduce the influence on operability perceived by a user. Therefore, even when the material used for the operation on the subject unit is changed, the user can proceed processing with the feeling prior to the change. Discomfort given to the user can thereby be reduced.

While certain example systems, methods, devices and apparatuses have been described herein, it is to be understood that the appended claims are not to be limited to the systems and methods, devices and apparatuses disclosed, but on the contrary, and are intended to cover various modifications and equivalent arrangements included within the spirit and scope of the appended claims.

What is claimed is:

1. An information processing apparatus comprising:
a detection unit configured to detect sound resulting from an operation performed on a unit subject to operation;
a calculation module configured to calculate an integrated value of magnitude of detected sound resulting from the operation over a predetermined period; and
a processing module configured to execute specific processing based on the integrated value of magnitude.

2. The information processing apparatus according to claim 1, further comprising an input unit including the subject unit, wherein
the detection unit is configured to detect sound when the operation is performed on the subject unit.

3. The information processing apparatus according to claim 2, wherein the input unit includes a touch panel.

4. The information processing apparatus according to claim 2, wherein the input unit includes a button.

5. The information processing apparatus according to claim 3, wherein the processing module is further configured to execute the specific processing based on a position where an input operation has been performed in addition to the integrated value of magnitude.

6. The information processing apparatus according to claim 4, wherein the processing module is further configured to execute the specific processing based on a position where an input operation has been performed in addition to the integrated value of magnitude.

7. The information processing apparatus according to claim 1, wherein the calculation module is further configured to calculate the integrated value over the predetermined period that is a fixed period.

8. The information processing apparatus according to claim 1, wherein the calculation module is further configured such that the predetermined period for which the integrated value is calculated is variable.

9. The information processing apparatus according to claim 8, wherein the calculation module is further configured to calculate the integrated value over a period in which the magnitude of detected sound is more than or equal to a predetermined value.

10. The information processing apparatus according to claim 1, wherein the processing module is further configured to calculate an operation amount on the subject unit based on the integrated value of magnitude, and executes the specific processing based on the operation amount.

11. The information processing apparatus according to claim 10, wherein the processing module is further configured to determine the operation amount on the subject unit using an index indicating hardness of a material used for the operation on the subject unit.

12. The information processing apparatus according to claim 11, wherein the index indicating hardness is a value based on a maximum value of the detected sound.

13. The information processing apparatus according to claim 10, wherein the processing module corrects the integrated value of magnitude such that the calculated operation amount on the subject unit is larger as the degree of hardness of a material used for the operation on the subject unit is smaller.

14. A non-transitory storage medium encoded with a computer readable information processing program, executed by a processor, the information processing program causing the processor to perform functionality comprising:
detecting sound resulting from an operation performed on a unit subject to operation;
calculating an integrated value of magnitude of detected sound resulting from the operation over a predetermined period; and
executing specific processing based on the integrated value of magnitude.

15. An information processing system comprising:
a detection unit configured to detect sound resulting from an operation performed on a unit subject to operation;
an acquisition module configured to acquire the result of detection made by the detection unit;
a calculation module configured to calculate an integrated value of magnitude of detected sound resulting from the operation over a predetermined period; and
a processing module configured to execute specific processing based on the integrated value of magnitude.

16. An information processing method executed in an information processing apparatus, comprising:
detecting sound resulting from an operation performed on a unit subject to operation;
calculating an integrated value of magnitude of detected sound resulting from the operation over a predetermined period; and
executing specific processing based on the integrated value of magnitude.
